(19) United States
(12) Patent Application Publication
(10) Pub. No.: US 2006/0062078 A1
(43) Pub. Date: Mar. 23, 2006

(54) Mixing member for blenders

(75) Inventor: Valter Jejcic, Nova Gorica (SI)

Correspondence Address: STAAS & HALSEY LLP, SUITE 700, 1201 NEW YORK AVENUE, N.W., WASHINGTON, DC, 20005, US

(73) Assignee: VALMAR IZDELAVA STROJEV IN PREPARATOV ZA SLADOLED IN SLASCICE D.O.O., Nova Gorica (SI)

(21) Appl. No.: 11/231,939

(22) Filed: Sep. 22, 2005

(30) Foreign Application Priority Data
Sep. 23, 2004 (IT) TO2004A000640

(51) Int. Cl. B01F 7/00; B01F 7/32

(52) U.S. Cl. 366/310; 366/312; 366/325.94

(57) ABSTRACT

A mixing member, which is mounted to rotate axially inside the cylindrical tub of a blender; the mixing member having a number of longitudinal blades, which extend parallel to a reference longitudinal axis of the mixing member, and are spaced angularly about the aforementioned longitudinal axis to form a squirrel-cage structure bounded laterally by a cylindrical reference surface coaxial with the aforementioned longitudinal axis; each of the longitudinal blades having an outer lateral edge lying on the cylindrical reference surface and the outer lateral edge of each longitudinal blade being fitted with a scraper shoe, which includes a supporting plate fixed rigidly to the outer lateral edge so as to be substantially tangent to the cylindrical reference surface, and a straight scraper body which rests on the outer face of the supporting plate, has a longitudinal ridge facing outwards of the mixing member, and is fixed to the supporting plate to slide freely on the surface of the outer face in a direction locally tangent to the cylindrical reference surface.

The present invention relates to a mixing member for blenders.

### BACKGROUND OF THE INVENTION

As is known, blenders are used for making home-made ice-cream, and normally comprise a cylindrical tub, into which the various ingredients for producing the desired amount of ice-cream are poured; a cooling assembly for cooling and keeping the tub and the contents at a temperature ranging between −10° C. and −35° C.; and a rotary mixing member mounted to rotate inside the tub to blend the various ingredients at the various stages in the preparation of the ice-cream.

In addition, the mixing member is shaped to continuously scrape the entire cylindrical inner surface of the tub to prevent the mixture of ingredients inside from clinging to the lateral wall of the tub, due to the low temperature of the tub.

More specifically, most currently marketed mixing members extend coaxially with a longitudinal axis which, in use, coincides with the axis of symmetry of the tub, and substantially comprise a number of elongated rectangular radial blades spaced angularly about the longitudinal axis of the mixing member; and two end connecting hubs coaxial with the longitudinal axis of the mixing member, on opposite sides of the blades, and shaped to connect the axial ends of the blades in between, and so form a rigid structure rotating freely about the longitudinal axis of the mixing member.

The radial blades normally extend helically, and are angularly spaced, about the longitudinal axis of the mixing member, so that the outer lateral edges of the blades lie on a cylindrical surface of a diameter approximately equal to but no greater than that of the tub; and one of the end hubs has a supporting shaft or pin projecting from the body of the hub, coaxially with the longitudinal axis of the mixing member, and terminating in a grooved head for connection to an electric motor housed inside the blender.

To scrape off the ice-cream clinging to the lateral wall of the tub, mixing members of the above type also comprise a number of plastic scraping appendixes or spatulas fixed to the outer lateral edges of the flat blades to move freely in the blade planes, i.e. radially; and a number of helical thrust springs located on the blades to push the various scraper appendixes radially outwards, so that each rests against the inner cylindrical surface of the lateral wall of the tub.

Though highly efficient, known mixing members have the major drawback of being fairly difficult to clean, on account of the tendency of the ice-cream to accumulate inside the cavities housing the helical springs and the scraper appendixes, with all the obvious problems this entails.

Known mixing members also have the drawback of operating poorly when the scraper appendixes are called upon to remove thicker and harder than normal ice-cream off the wall of the tub, e.g. due to more intense cooling of the lateral wall of the tub. In which case, in fact, the elastic force of the helical springs may not be sufficient to hold the scraper appendixes against the lateral wall of the tub.

### SUMMARY OF THE INVENTION

It is an object of the present invention to provide a mixing member for blenders, designed to eliminate the aforementioned drawbacks, and which is also cheaper to produce.

According to the present invention, there is provided a mixing member for blenders, which is mounted to rotate axially inside the tub of a blender; said tub being substantially cylindrical, and the mixing member comprising a number of longitudinal blades, which extend substantially parallel to a reference longitudinal axis of the mixing member, and are spaced angularly about said longitudinal axis to form a substantially “squirrel-cage” structure bounded laterally by a cylindrical reference surface coaxial with said longitudinal axis; at least one of said longitudinal blades having an outer lateral edge lying on said cylindrical reference surface, and the mixing member having scraping means located on said outer lateral edge to rest against the inner cylindrical surface of the tub when the mixing member is inserted inside the tub; the mixing member being characterized in that said scraping means comprise at least one scraper shoe, in turn comprising a supporting plate fixed to the outer lateral edge of said longitudinal blade so as to be substantially tangent to said cylindrical reference surface, and a straight scraper body which rests on the outer face of said supporting plate, has a longitudinal ridge facing outwards of the mixing member, and is fixed to the supporting plate to slide freely on the surface of the outer face in a direction locally tangent to said cylindrical reference surface.

### BRIEF DESCRIPTION OF THE DRAWINGS

A non-limiting embodiment of the present invention will be described by way of example with reference to the accompanying drawings, in which:

FIG. 1 shows a view in perspective of a mixing member for blenders, in accordance with the teachings of the present invention;

FIG. 2 shows a side view, with parts removed for clarity, of a portion of the FIG. 1 mixing member;

FIG. 3 shows a section along line III-III of the FIG. 2 portion of the mixing member.

### DETAILED DESCRIPTION OF THE INVENTION

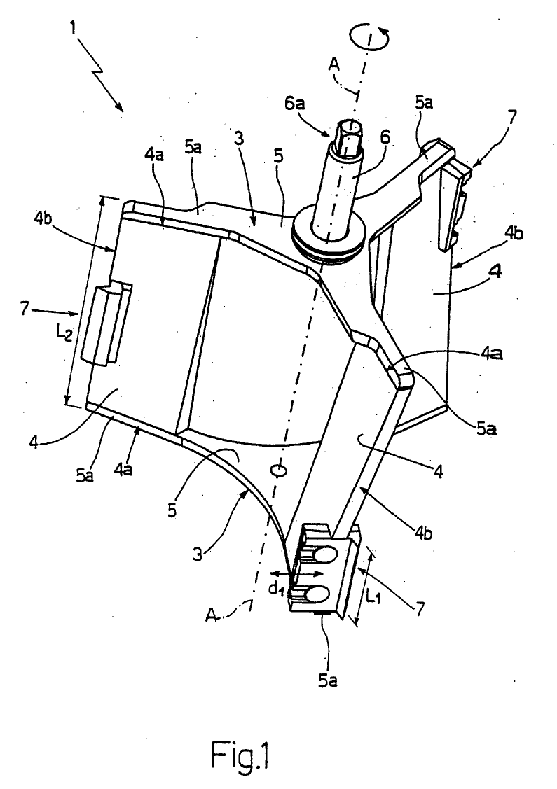

With reference to FIGS. 1, 2 and 3, number 1 indicates as a whole a rotary mixing member specially designed to be mounted for rotating axially inside the tub 2 of a known blender, wherein tub 2 is substantially cylindrical with radius of curvature R₁ of the inner cylindrical surface preferably, though not necessarily, ranging between 10 and 20 centimetres.

With reference to FIG. 1, mixing member 1 extends coaxially with a longitudinal axis A coinciding, in use, with the longitudinal axis of symmetry (not shown) of tub 2, and comprises two supporting hubs 3 coaxial with longitudinal axis A and a given distance apart; and a number of longitudinal blades 4, which extend from one supporting hub 3 to the other, are substantially parallel to longitudinal axis A of mixing member 1, and are spaced angularly about the same axis to form a “squirrel-cage” structure bounded laterally by a cylindrical reference surface coaxial with longitudinal axis A of mixing member 1 and having a radius of curvature smaller than the radius of curvature R₁ of tub 2, so as to permit insertion and rotation of mixing member 1 inside tub 2.

More specifically, in the example shown, the radius of curvature of said cylindrical reference surface is approximately equal to but no greater than the radius of curvature R₁ of tub 2.

Preferably, though not necessarily, longitudinal blades 4 are arranged about longitudinal axis A of mixing member 1 so as to be equidistant from and equally spaced angularly about longitudinal axis A, and so form a perfectly cylindrical “squirrel-cage” structure.

With reference to FIG. 1, in the example shown, longitudinal blades 4 are three in number, and each defined by a flat, elongated rectangular plate 4 of stainless steel, which has two minor lateral edges 4a fixed rigidly to respective supporting hubs 3, and extends substantially helically about longitudinal axis A of mixing member 1, while remaining locally radial with respect to longitudinal axis A, so that one of the two major lateral edges of the plate—hereinafter also referred to as outer lateral edge 4b of the blade—lies on said cylindrical reference surface.

In other words, longitudinal blades 4 as a whole are inscribed within a cylindrical reference surface coaxial with longitudinal axis A of mixing member 1 and having a radius of curvature approximately equal to but no greater than the radius of curvature R₁ of tub 2.

In the example shown, the two supporting hubs 3 are each defined by a flat, stainless steel plate 5 lying in a plane perpendicular to longitudinal axis A of mixing member 1, and substantially star-shaped with a number of projecting appendixes 5a, which project radially from the central body to minor lateral edges 4a of longitudinal blades 4. Projecting appendixes 5a are equal in number to longitudinal blades 4, are equally spaced angularly about longitudinal axis A of mixing member 1, and are so sized that minor lateral edges 4a of longitudinal blades 4 can each be fixed to a respective projecting appendix 5a to form a rigid structure which rotates freely about longitudinal axis A of mixing member 1 inside tub 2.

In addition, one of the two supporting hubs 3 also has a supporting shaft or pin 6, which projects from the centre of the corresponding flat plate 5, coaxially with longitudinal axis A of mixing member 1, and terminates with a grooved head 6a for connection to an electric motor housed in the blender, just beneath the bottom of tub 2. In the example shown, supporting shaft 6 is obviously made of stainless steel like the flat plate 5 with which it is integral.

With reference to FIGS. 1, 2 and 3, mixing member 1 also comprises a number of scraper shoes 7 located on outer lateral edges 4b of longitudinal blades 4, and each designed to slide seamlessly on the inner cylindrical surface of tub 2 to prevent the mixture of ingredients in tub 2 from adhering to the lateral wall of the tub.

In the example shown, scraper shoes 7 are equal in number to longitudinal blades 4, and each comprise a supporting plate 8 fixed rigidly and flat to outer lateral edge 4b of longitudinal blade 4, so as to be locally tangent to the cylindrical reference surface defined by outer lateral edges 4b of longitudinal blades 4; and a straight scraper body 9, which has a complex polygonal section, rests on the outer face 8a of supporting plate 8 with its own longitudinal axis substantially parallel to longitudinal axis A of mixing member 1, has a longitudinal ridge 9a facing outwards of mixing member 1, and is fixed to supporting plate 8 to slide freely on the surface of face 8a in a direction d₁, which lies in a plane substantially perpendicular to longitudinal axis A of the mixing member, and which is locally substantially tangent to the cylindrical reference surface defined by outer lateral edges 4b of longitudinal blades 4.

In other words, straight scraper body 9 is fixed to face 8a of supporting plate 8 to slide freely on face 8a in a direction d₁ perpendicular to the longitudinal axis of straight scraper body 9 and locally substantially tangent to the cylindrical reference surface defined by outer lateral edges 4b of longitudinal blades 4, i.e. locally perpendicular to the generating line of the cylindrical reference surface defined by outer lateral edges 4b.

More specifically, with reference to FIG. 3, straight scraper body 9 is preferably, though not necessarily, designed to move, at outer lateral edge 4b of longitudinal blade 4, along a cylindrical surface parallel to longitudinal axis A and having a radius of curvature R₂ smaller than the radius of curvature R₁ of the inner cylindrical surface of tub 2 and the radius of curvature of said cylindrical reference surface, while remaining parallel at all times to itself and to longitudinal axis A of mixing member 1.

In the example shown, supporting plate 8 is preferably, though not necessarily, made of stainless steel, and is shaped so that outer face 8a has a cylindrical profile, the generating line of which is parallel at all times to longitudinal axis A of mixing member 1, and the radius of curvature R₂ of which is smaller than the radius of curvature R₁ of the inner cylindrical surface of tub 2 and the radius of curvature of said cylindrical reference surface.

Straight scraper body 9, on the other hand, is defined by a straight, substantially L-section bar, which is preferably, though not necessarily, made of plastic material, and is positioned on outer face 8a of supporting plate 8 with its major flat portion resting on face 8a of supporting plate 8, and with its minor flat portion facing in the travelling direction ω of straight scraper body 9 inside tub 2. The minor flat portion also faces outwards of the cylindrical reference surface, so that its longitudinal edge rests, and therefore slides, on the inner cylindrical surface of tub 2, and so defines ridge 9a of straight scraper body 9.

In other words, straight bar 9 is positioned on outer face 8a of supporting plate 8 so that its flat flank 9b, terminating in edge or ridge 9a, faces in the travelling direction ω of straight scraper body 9 inside tub 2.

In addition, straight bar 9 is shaped so that its flat major portion resting on supporting plate 8 has a curved profile complementary to that of face 8a, and can therefore slide freely on face 8a while remaining parallel to itself at all times.

In the example shown, straight scraper body 9 is fixed in sliding manner to supporting plate 8 by two round-headed screws 10, which are screwed partly in outer face 8a of supporting plate 8, are aligned on supporting plate 8 along an axis parallel to longitudinal axis A of mixing member 1, and each engage in sliding manner a respective transverse slot 11 which extends in straight scraper body 9 perpendicular to its longitudinal axis, i.e. perpendicular to longitudinal axis A of mixing member 1.

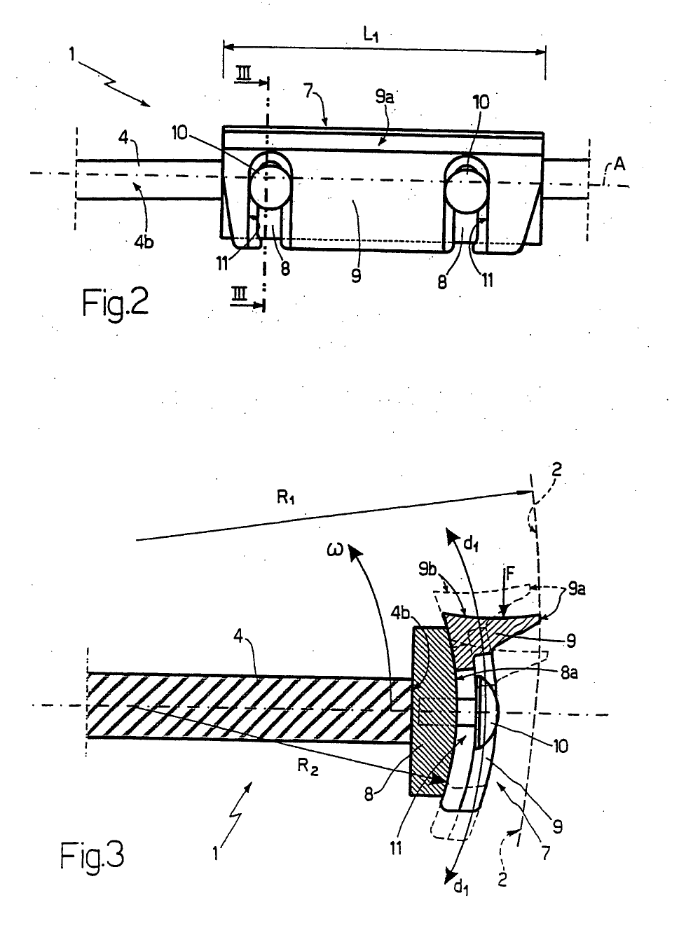

With reference to FIGS. 1 and 2, in the example shown, scraper shoes 7 are designed so that the axial length L₁ of straight scraper bodies 9 is less than the axial length L₂ of longitudinal blades 4, and are appropriately offset with respect to one another on outer lateral edges 4b of longitudinal blades 4 so as to be distributed axially along the whole portion of mixer member 1 immersed inside tub 2.

More specifically, in the example shown, straight scraper bodies 9 have an axial length L₁ approximately equal to but no less than a third of the total axial length L₂ of longitudinal blades 4, and are appropriately offset with respect to one another on outer lateral edges 4b of respective longitudinal blades 4 so as each to scrape a third of the inner cylindrical surface of tub 2. Longitudinal blades 4 of mixing member 1, in fact, are approximately equal to but no smaller than the depth of tub 2.

Operation of mixing member 1 is easily deducible from the foregoing description and accompanying drawings, with no further explanation required, except to point out that mixing member 1 is designed to rotate about its longitudinal axis A in a rotation direction which tends to bring flank 9b of straight scraper body 9 into direct contact with the ice-cream clinging to the lateral wall of tub 2, so that the mechanical force F produced by the ice-cream accumulating on flank 9b tends to back up straight scraper body 9 on supporting plate 8, thus bracing ridge 9a of straight scraper body 9 against the wall of tub 2 with gradually increasing force.

The advantages of scraper shoes 7 as described above are obvious: mixing member 1 described has no recesses in which the product being mixed can accumulate, and is therefore extremely easy to clean.

Moreover, in mixing member 1, the mechanical force F pressing ridge 9a of straight scraper body 9 against the inner cylindrical surface of tub 2 increases alongside an increase in the consistency and hardness of the ice-cream accumulating upstream from straight scraper body 9, so that mixing member 1 provides for thoroughly cleaning the lateral wall of tub 2 even when producing ice-cream at lower than normal temperatures, i.e. below −20° C.

Clearly, changes may be made to rotary mixing member 1 as described and illustrated herein without, however, departing from the scope of the present invention.

For example, straight scraper bodies 9 may be in the form of a substantially triangular-section prism, or of any form having a straight edge resting on the inner cylindrical surface of tub 2, and may even be inclined with respect to longitudinal axis A of mixing member 1.

In a further variation, a single scraper shoe 7 may be fixed to outer lateral edge 4b of one longitudinal blade 4, or one or more scraper shoes 7 may be used in combination with other known scraper members.

In addition, mixing member 1 may only comprise the supporting hub 3 defined by substantially star-shaped flat plate 5 and by supporting shaft 6 projecting from the centre of flat plate 5 and coaxial with longitudinal axis A of mixing member 1. In which case, the whole defined by flat plate 5, longitudinal blades 4, and supporting shaft 6 must obviously be designed to achieve adequate structural rigidity.

1) A mixing member (1) for blenders, which is mounted to rotate axially inside the tub (2) of a blender; said tub (2) being substantially cylindrical, and the mixing member (1) comprising a number of longitudinal blades (4), which extend substantially parallel to a reference longitudinal axis (A) of the mixing member (1), and are spaced angularly about said longitudinal axis (A) to form a substantially “squirrel-cage” structure bounded laterally by a cylindrical reference surface coaxial with said longitudinal axis (A); at least one of said longitudinal blades (4) having an outer lateral edge (4b) lying on said cylindrical reference surface, and the mixing member (1) having scraping means located on said outer lateral edge (4b) to rest against the inner cylindrical surface of the tub (2) when the mixing member (1) is inserted inside the tub; the mixing member (1) being characterized in that said scraping means comprise at least one scraper shoe (7), in turn comprising a supporting plate (8) located on the outer lateral edge (4b) of said longitudinal blade (4) so as to be substantially tangent to said cylindrical reference surface, and a straight scraper body (9) which rests on the outer face (8a) of said supporting plate (8), has a longitudinal ridge (9a) facing outwards of the mixing member (1), and is fixed to the supporting plate (8) to slide freely on the surface of the outer face (8a) in a direction (d₁) locally substantially tangent to said cylindrical reference surface.

2) A mixing member as claimed in claim 1, characterized in that said straight scraper body (9) is mounted movably on the outer face (8a) of said supporting plate (8) along a cylindrical surface parallel to said longitudinal axis (A) and having a radius of curvature (R₂) smaller than the radius of curvature of said cylindrical reference surface.

3) A mixing member as claimed in claim 2, characterized in that said supporting plate (8) is shaped so that its outer face (8a) has a cylindrical profile, the generating line of which is parallel to the longitudinal axis (A) of the mixing member (1), and the radius of curvature (R₂) of which is smaller than the radius of curvature of said cylindrical reference surface; said straight scraper body (9) being shaped so that the portion resting on said supporting plate (8) has a curved profile complementary to that of said outer face (8a).

4) A mixing member as claimed in claim 1, characterized in that said straight scraper body (9) is fixed in sliding manner to said supporting plate (8) by a number of screws (10), which are screwed partly inside the outer face (8a) of the supporting plate (8), and each engage in sliding manner a respective transverse slot (11) formed in the straight scraper body (9).

5) A mixing member as claimed in claim 1, characterized in that said straight scraper body (9) extends parallel to the longitudinal axis (A) of the mixing member (1).

6) A mixing member as claimed in claim 5, characterized in that said straight scraper body (9) has a substantially L-shaped cross section.

7) A mixing member as claimed in claim 5, characterized in that said straight scraper body (9) is made of plastic material.

8) A mixing member as claimed in claim 1, characterized in that each said longitudinal blade (4) has an outer lateral edge (4b) lying on said cylindrical reference surface.

9) A mixing member as claimed in claim 8, characterized in that each said longitudinal blade (4) is defined by a flat, elongated rectangular plate (4) extending substantially helically about the longitudinal axis (A) of the mixing member (1) while remaining locally radial with respect to the longitudinal axis (A).

10) A mixing member as claimed in claim 1, characterized in that the radius of curvature of said cylindrical reference surface is approximately equal to but no greater than the radius of curvature (R₁) of the inner cylindrical surface of said tub (2).
